(19) United States
(12) Patent Application Publication
(10) Pub. No.: US 2004/0142148 A1
(43) Pub. Date: Jul. 22, 2004

(54) Environmental friendly artificial leather product and method for producing same

(76) Inventors: Chung-Ching Feng, Kaohsiung (TW); Pei-Huo Huang, Kaohsiung (TW); Yong-Song Lin, Kaohsiung (TW); Mong-Ching Lin, Kaohsiung (TW); Ching-Tang Wang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/754,295

(22) Filed: Jan. 9, 2004

(30) Foreign Application Priority Data
Jan. 13, 2003 (TW) 92100749

(51) Int. Cl. B32B 1/00

(52) U.S. Cl. 428/151; 427/256; 427/407.1; 156/246

(57) ABSTRACT

An environmental friendly artificial leather product includes a substrate, an adhesive layer, an intermediate layer and a top layer. The artificial leather resides in that the top layer and adhesive layer is formed of a solvent-free elastomer resin composition and the intermediate layer provided between the top layer and adhesive layer is formed of a polyurethane resin composition containing more than 50% by weight solid content of polyurethane resin. A method for producing an environmental friendly artificial leather product includes coating a first solvent-free elastomer resin composition on a releasing paper to form a top layer, coating a polyurethane resin composition containing more than 50% by weight solid content on the top layer to form an intermediate layer, coating a second solvent-free elastomer resin composition on the intermediate layer to form an adhesive layer, and finally applying a substrate on the adhesive layer, and peeling the releasing paper.

### BACKGROUND OF THE INVENTION

1. Field of the Invention

The present invention relates to a method for producing an environmental friendly artificial leather product and environmental friendly artificial leather product made therefrom.

2. Description of the Related Art

A conventional method for producing genuine-like artificial leather as shown in FIG. 1 comprises two main processes, one being a dry process 100 and other being a wet process 101. The dry process 100 comprises two main steps 102 and 104, i.e., coating a dry polyurethane resin composition on a releasing paper to form a layer of dry polyurethane resin having a thickness ranging from 0.02 mm to 0.03 mm (step 102) and then coating a polyurethane resin composition for adhesion on the dry polyurethane resin layer to form an adhesive layer having a thickness ranging from 0.04 mm to 0.05 mm (step 104). The wet process 101 comprises four main steps 106 to 114, i.e., immersing a substrate into a polyurethane resin composition for immersion to form a immersion layer (step 106), coating a polyurethane resin composition for coating on the substrate to form a coagulating layer (step 110), and washing the coagulating layer (step 112) and then dry to form a foaming layer on the substrate. Finally, the product obtained from the dry process is bonded with its adhesive layer to the foam layer of the product obtained from the wet process (step 114). After peeling the releasing paper (step 116), genuine-like artificial leather is obtained.

However, the dry polyurethane resin and the polyurethane resin for adhesion involved in the dry process or the polyurethane resin for immersion and polyurethane resin for coating involved in the wet process contain a considerable amount of organic solvent, for example methyl ethyl ketone (MEK), dimethyl formamide (DMF), and toluene. During forming the dry polyurethane resin layer or curing the adhesion layer, a dry step is required to completely remove organic solvents in the compositions. It is required to replace organic solvents contained in the immersion layer and foaming layer with water so that organic solvents are dissolved in water and then recovered in recovery installations. The organic solvents are inflammable and easy to induce fire accidents. The organic solvents are also toxic which not only induce hazard to human bodies but environmental pollution.

Nowadays, in order to solve pollution problems, the water borne polyurethane resin layer used to be applied to a releasing paper is directly applied to non-woven fabric or fabric. However, the artificial leather obtained does not provide thickness and flexibility similar to those of genuine leathers. Hence, the artificial leather provides neither good hand touch, bending property nor thickness touch. Furthermore, to improve the hand touch of the artificial leather based on water borne polyurethane resin layer, water borne polyurethane resin layer used to be applied to releasing papers have been directly applied to wet semi-products of artificial leather having foaming layers. However, the preparation of wet semi-products of artificial leather (referring to set process 101) still requires a considerable amount of organic solvents. Although the preparation of the surface layer of the artificial leather mentioned previously is environmental friendly, the preparation of the inner layer of the wet semi-products of the artificial leather still requires a considerable amount of organic solvents which pollutes the environment.

Therefore, it is the purpose of the present invention to mitigate and/or obviate the drawbacks existing in the prior art in the manner set forth below.

### SUMMARY OF THE INVENTION

Accordingly, it is an object of this invention to provide a method for producing an environmental friendly artificial leather product wherein the amount of organic solvent used is considerably reduced.

It is an object of this invention to provide a method for producing an environmental friendly artificial leather product wherein the artificial leather product has thickness touch and bending property similar to those of genuine leathers.

In order to accomplish the above and other objects, the subject invention provides a method for producing an environmental friendly artificial leather product mainly comprising coating a first solvent-free elastomer resin composition on a releasing paper to form a top layer having a thickness ranging from 0.02 mm to 0.2 mm, coating a layer of polyurethane resin composition having over 50% by weight solid content of polyurethane resin on the top layer to form an intermediate layer having a thickness ranging from 0.2 mm to 3 mm, coating a second solvent-free elastomer resin composition on the intermediate layer to form an adhesive layer, and bonding a substrate having a thickness ranging from 0.5 mm to 3 mm to the to adhesive layer and peeling the releasing paper.

The solvent-free elastomer resin composition suitable for the subject invention includes elastomer resin composition containing no or little organic solvent, for example, water-soluble elastomer resin composition and water dispersed elastomer resin composition. During the method of producing the artificial leather, the solvent-free elastomer resin composition would not produce or merely produce a slight amount of organic solvent so that the environment friendly purpose is achieved.

The subject invention is characterized by using the polyurethane resin composition having over 50% by weight solid content of polyurethane resin to form an intermediate layer having a thickness far more than that of the top layer and the adhesive layer. The polyurethane resin composition having a larger amount of solid content has a relatively small amount of organic solvent and has a thickness, after being dried, similar to that being coated. The polyurethane resin composition can easily form the intermediate layer having a larger thickness and obtain genuine-like thickness and bending property.

The subject invention further provides an environmental artificial leather product comprising a substrate, an adhesive layer, an intermediate layer and a top layer. The environmental artificial leather product is characterized in that the top layer and adhesive layer is formed of a solvent-free elastomer resin composition and the intermediate layer provided between the top layer and adhesive layer is formed of a polyurethane resin composition containing over 50% by weight solid content of polyurethane resin.

### BRIEF DESCRIPTION OF THE DRAWINGS

FIG. 1 represents a flowing chart for a conventional method for producing artificial leather.

FIG. 2 represents a flowing chart for a method of producing environmental artificial leather product of an embodiment of the subject invention.

FIGS. 3a through 3e represent a cross-section of a method of producing environmental artificial leather product of an embodiment of the subject invention.

### DETAILED DESCRIPTION OF THE PREFERRED EMBODIMENT

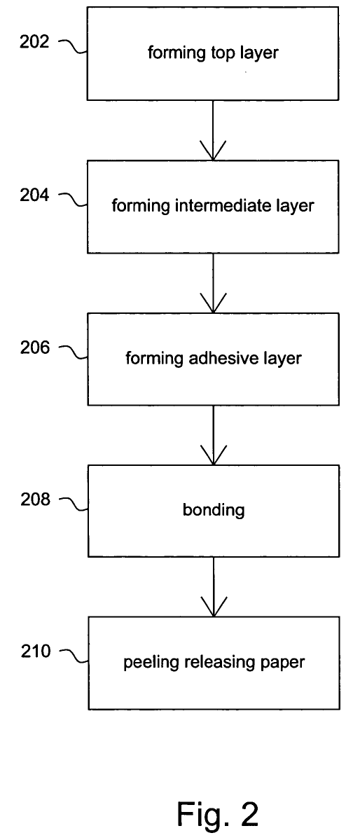

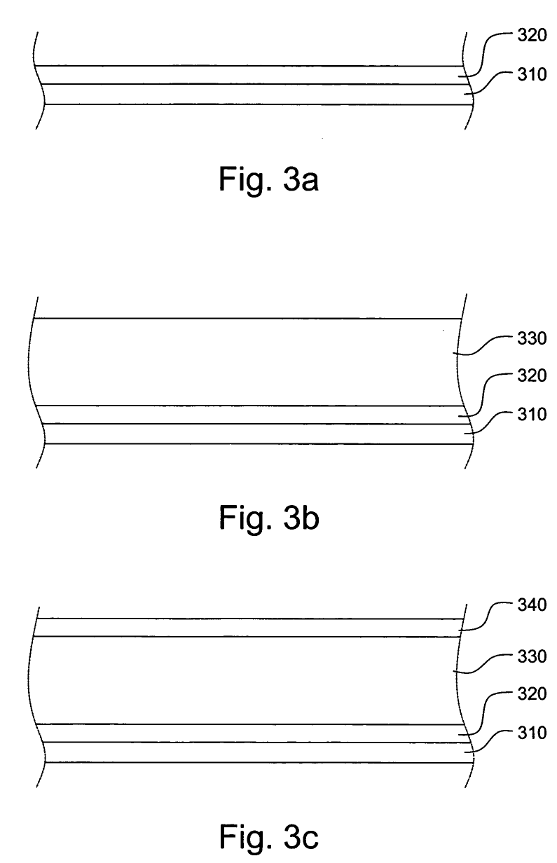

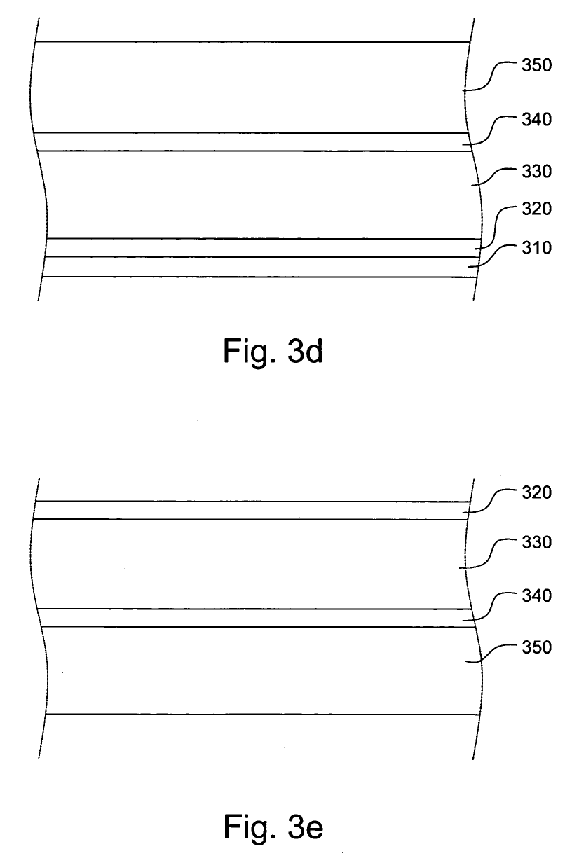

The environmental artificial leather product of the subject invention will be further explained in reference to FIG. 2 and FIGS. 3a to 3e. Firstly, in step 202 (referring to FIG. 3a), a layer of solvent-free elastomer resin composition is coated on a releasing paper 310 to form a top layer 320, after being dried. In step 204 (referring to FIG. 3b), a layer of polyurethane resin composition containing a high solid content is coated on the top layer 320 and dried and cured to form an intermediate layer 330. Then, in step 206 (referring to FIG. 3c), a layer of solvent-free elastomer resin composition is coated on the intermediate layer to form an adhesive layer 340. Finally, in step 208 (referring to FIG. 3d), a substrate is bonded on the adhesive layer 340. After drying and curing the adhesive layer, in step 210 (referring to FIG. 3e), the releasing paper is peeled to form an environmental friendly artificial leather product. In the text of the invention, “solvent-free elastomer resin composition” means elastomer resin composition containing no or merely a minor amount of organic solvent.

One characteristic of the subject invention resides in the use of the solvent-free elastomer resin composition to form the top layer 320 and adhesive layer 340. The solvent-free elastomer resin composition suitable for forming the top layer 320 includes water soluble elastomer resin composition and water dispersed elastomer resin composition. The solvent-free elastomer resin composition suitable for the adhesive layer 340 includes water-soluble elastomer resin composition, water dispersed elastomer resin composition, and solvent-free wet curing elastomer resin composition. Suitable water dispersed elastomer resin composition includes solvent-free water-soluble polyurethane resin IMPRANIL DLS, available from Bayer CHEM Co. Ltd. Suitable water dispersed elastomer resin composition includes water dispersed polyurethane resin IMPRANIL DLP, available from Bayer CHEM Co. Ltd. The elastomer of the solvent-free elastomer resin composition is selected from the group consisting of polyurethane, polyamino acid and acrylate. In consideration of the hand touch and various physical properties of the environmental friendly artificial leather product, the polyurethane is preferable. During the preparation of the environmental friendly artificial leather product, as the solvent-free elastomer resin composition contains no or merely a minor amount of organic solvent, the forming of the top layer 320 and adhesive layer 340 would not release or merely release a minor amount of organic solvent so that the environmental friendly purpose are achieved.

Solvent-free elastomer resin composition having 10% to 90% by weight of solid content elastomer, preferably 35% to 60% by weight of solid content elastomer, is used to form the top layer 320 having a thickness ranging from 0.02 mm to 0.2 mm after being dried at about 80 to 140° C.

Another characteristic of the subject invention resides in the use of polyurethane resin composition having a high solid content to form an intermediate layer 330 having a thickness ranging from 0.2 mm to 3 mm, much more than that of the top layer 320 and adhesive layer 340 so as to provide thickness and flexible touch. Polyurethane resin composition suitable for forming the intermediate layer 330 includes preferably 50% by weight of solid content, more preferably at least 98% by weight of solid content. Specifically, polyurethane resin composition having high solid content contains a relatively minor amount of organic solvent and would not release a considerable amount of organic solvent during the preparation of the intermediate layer 330. Furthermore, the thickness difference between the polyurethane resin composition having a high solid content will have a thickness, after being dried, quite similar to that of being coated. It is easy to form a thicker intermediate layer 330 having a thickness tough and bending property similar to those of genuine leather. Furthermore, to form an intermediate layer having a better flatness or other properties, the polyurethane resin composition having high solid content can includes 0 to 5% surfactant, 5% to 10% curing agent or 3% to 10% pigment. In accordance with the examples of the subject invention, the polyurethane resin composition having high solid content is dried at temperature ranging from 110 to 200° C. to form the intermediate layer 330. In addition, a foaming agent can be added to the polyurethane resin composition having high solid content to form a porous intermediate layer 330. Preferably, the polyurethane resin composition can be subjected to vacuum de-gassing prior to coating.

The substrate 350 can be bonded to the adhesive layer 340 prior to drying the adhesive layer 340 or be bonded to the adhesive layer 340 when the adhesive layer 340 is only slightly dried and is still sticky. Then, an environmental friendly artificial leather semi-product is obtained. Preferably, the environmental friendly artificial leather semi-product is subjected to a curing chamber for about 24 to 48 hours to render the adhesive layer cross-linking. Substrate suitable for the subject invention includes woven fabric, non-woven fabric or animal skin having a thickness ranging from 0.5 mm to 3 mm.

According to the above preparation, the subject invention further provides an environmental artificial leather product shown in FIG. 3e comprising a substrate 350, an adhesive layer 340, an intermediate layer 330 and a top layer 320. The environmental artificial leather product is characterized in that the top layer 320 and adhesive layer 340 is formed of a solvent-free elastomer resin composition and the intermediate layer 320 provided between the top layer 320 and adhesive layer 340 is formed of a polyurethane resin composition containing more than 50% by weight solid content of polyurethane resin.

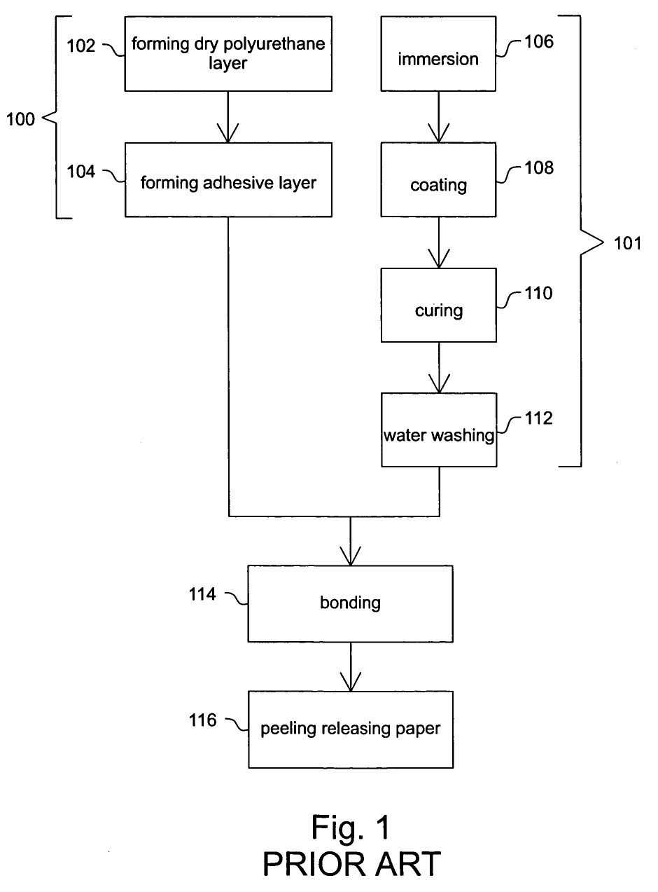

Referring to FIGS. 1 and 2, in addition to environmental friendly effect, the subject invention provides a method of producing an environmental friendly artificial leather product which does not need wet process involved in conventional technique, so as to significantly simplify the procedures of the method of producing artificial leather and increase production yield.

The following examples are to illustrate, rather than to limit, the subject invention.

### EXAMPLE

A releasing paper is coated with a solvent-free polyurethane resin coating having 50% by weight solid content of polyurethane resin and a viscosity of 1300 cps/30° C. The releasing paper is dried in an oven at a temperature of 120° C. to dry the water soluble polyurethane resin coating to become a top layer.

The dried top layer is coated with a polyurethane resin coating having a high solid content. The coating contains polyurethane resin having 98% by weight solid content and additives (surfactant, curing agent and pigments) in a ratio of 5:1 and has a viscosity of 25000 cps/30° C. The polyurethane resin coating having a high solid content on the top layer is dried and cured in an oven at a temperature of 160° C. to form an intermediate layer.

The cured intermediate layer is coated with a layer of solvent-free polyurethane resin coating having water borne cross-linking agent therein to form an adhesive layer. The adhesive layer is dried in an oven to slightly dry the solvent-free polyurethane resin coating and allow the adhesive sticky. A non-woven fabric having a thickness of 1.0 mm is boned to the adhesive layer. The adhesive layer is dried in an oven to dry the solvent-free polyurethane resin coating to form an environmental friendly artificial leather semi-product.

The environmental friendly artificial leather semi-product is subjected to a curing step in a curing chamber at a temperature of 50° C. for 24 hours to allow the adhesive layer having cross-linking structure. Finally, the releasing paper is peeled from the top layer to result in artificial leather having a thickness touch, high peeling strength, and high bending.

The artificial leather in accordance with the subject invention is compared with the non-environmental products obtained from the conventional method comprising dry process and wet process. The comparison is shown in Table 1 as follows:

| | Product | | |
|---|---|---|---|
| | Non-environmental | The subject | |
| | artificial leather product | invention | Testing standard |
| Thickness | 1.30 mm | 1.30 mm | ASTM D-1777 |
| Weight | 675 g/m² | 720 g/m² | ASTM D-3776 |
| Peeling | 2.5 kg/cm | 3.5 kg/cm | DIN-53273 |
| strength | | | |
| Flexibility | Qualify for 100000 | Qualify for | DIN-53351 |
| | cycles (25° C.) | 100000 cycles | |
| | | (25° C.) | |
| Abrasion | 2000 cycles | More than | ASTM D-3885 |
| (STOLL) | | 3000 cycles | |
| Tensile | 15 kg/cm | 25 kg/cm | ASTMD |
| strength | | | 1682/D1117 |
| Hydrolysis | Jungle test (3 weeks) | Jungle test | ASTM D 3690 |
| | | (7 weeks) | |

Table 1 shows that the environmental artificial leather product in accordance with the subject invention has significant improvements in peeling strength, bending and abrasion compared to those of the conventional method involving a considerable amount of organic solvent. The method of the subject invention uses a slight amount or even no organic solvent compared to the conventional method so as to achieve the purpose for human health and environment protection.

While the present invention has been explained in relation to its preferred embodiments and illustrated with various drawings, it is to be understood that the embodiments shown in the drawings are merely exemplary and that various modifications of the invention will be apparent to those skilled in the art upon reading this specification. Therefore, it is to be understood that the invention disclosed herein is intended to cover all such modifications as shall fall within the scope of the appended claims.

What is claimed is:

1. A method for producing environmental friendly artificial leather product, comprising:
coating a first solvent-free elastomer resin composition on a releasing paper to form a top layer,
coating a layer of polyurethane resin composition containing more than 50% by weight solid content of polyurethane resin on said top layer to form an intermediate layer,
coating a layer of a second solvent-free elastomer resin composition on said intermediate layer to form an adhesive layer,
bonding a substrate on said adhesive layer to form an environmental friendly artificial semi-product, and
peeling the releasing paper from said top layer to obtain environmental friendly artificial leather product.

2. A method for producing environmental friendly artificial leather product according to claim 1, wherein said first solvent-free elastomer resin composition is water soluble elastomer resin composition or water dispersed elastomer resin composition.

3. A method for producing environmental friendly artificial leather product according to claim 1, wherein said elastomer of said first solvent-free elastomer resin composition is select from the group consisting polyurethane, polyamino acid and acrylate.

4. A method for producing environmental friendly artificial leather product according to claim 1, wherein said first solvent-free elastomer resin composition comprises about 10% to 90% by weight solid content of elastomer.

5. A method for producing environmental friendly artificial leather product according to claim 1, wherein the step of forming said top layer further comprises a step of drying said first solvent-free elastomer resin composition at a temperature of about 80 to 140° C.

6. A method for producing environmental friendly artificial leather product according to claim 1, wherein said polyurethane resin composition containing more than 50% by weight solid content of polyurethane resin comprises about 0 to 5% by weight of surfactant and about 5% to 10% by weight of curing agent.

7. A method for producing environmental friendly artificial leather product according to claim 1, wherein the step of forming said intermediate layer further comprises a step of drying the said polyurethane resin composition containing more than 50% by weight solid content of polyurethane resin.

8. A method for producing environmental friendly artificial leather product according to claim 1, further comprising subjecting said polyurethane resin composition containing more than 50% by weight solid content of polyurethane resin to vacuum de-gassing prior to coating said polyurethane resin composition.

9. A method for producing environmental friendly artificial leather product according to claim 1, wherein said second solvent-free elastomer resin composition is water soluble elastomer resin composition, water dispersed elastomer resin composition or solvent-free wet curing elastomer resin composition.

10. A method for producing environmental friendly artificial leather product according to claim 1, wherein said elastomer of said second solvent-free elastomer resin composition is select from the group consisting polyurethane, polyamino acid and acrylate.

11. A method for producing environmental friendly artificial leather product according to claim 1, wherein said substrate is bonded to said substrate prior to drying said second solvent-free elastomer resin composition.

12. A method for producing environmental friendly artificial leather product according to claim 1, wherein said substrate is woven fabric, non-woven fabric or animal skin.

13. A method for producing environmental friendly artificial leather product according to claim 1, further comprising a step of subjecting said artificial leather semi-product to a temperature of about 40 to 60° C. for about 24 to 48 hours to form a cross-linking structure in said adhesive layer prior to peeling said releasing paper.

14. An environmental friendly artificial leather product, comprising:
a substrate,
an adhesive layer formed of a first solvent-free elastomer resin composition on a side of said substrate,
an intermediate layer formed of polyurethane resin composition containing more than 50% by weight solid content of polyurethane resin on said adhesive layer, and
a top layer formed of a second solvent-free elastomer resin composition on said intermediate layer.

15. An environmental friendly artificial leather product according to claim 14, wherein said first solvent-free elastomer resin composition is water soluble elastomer resin composition, water dispersed elastomer resin composition or solvent-free wet curing elastomer resin composition.

16. An environmental friendly artificial leather product according to claim 14, wherein said elastomer of said first solvent-free elastomer resin composition is select from the group consisting polyurethane, polyamino acid and acrylate.

17. An environmental friendly artificial leather product according to claim 14, wherein said polyurethane resin composition containing more than 50% by weight solid content of polyurethane resin comprises about 0 to 5% by weight of surfactant and about 5% to 10% by weight of curing agent.

18. An environmental friendly artificial leather product according to claim 14, wherein said second solvent-free elastomer resin composition is water soluble elastomer resin composition or water dispersed elastomer resin composition.

19. An environmental friendly artificial leather product according to claim 14, wherein said elastomer of said second solvent-free elastomer resin composition is select from the group consisting polyurethane, polyamino acid and acrylate.

20. An environmental friendly artificial leather product according to claim 14, wherein said second solvent-free elastomer resin composition comprises about 10% to 90% by weight solid content of elastomer.
